(19) United States
(12) Patent Application Publication
(10) Pub. No.: US 2023/0236993 A1
(43) Pub. Date: Jul. 27, 2023

(54) SHARED MEMORY ACCELERATOR INVOCATION

(71) Applicant: Intel Corporation, Santa Clara, CA (US)

(72) Inventors: Gordon MCFADDEN, Beaverton, OR (US); Laurent COQUEREL, Limerick (IE); Fei Z. WANG, Shannon (IE); John J. BROWNE, Limerick (IE)

(21) Appl. No.: 18/130,410

(22) Filed: Apr. 3, 2023

(51) Int. Cl. G06F 13/16

(52) U.S. Cl. CPC G06F 13/16; G06F 2213/16

(57) ABSTRACT

An apparatus is described. The apparatus includes a memory management unit. The memory management unit is to receive a memory access request from an accelerator, wherein the memory access request includes a virtual address of a payload provided by an application that invokes the accelerator to perform a function on the payload, wherein. The memory access request also includes an identifier of the application's CPU process. The memory management unit is to translate the virtual address to a physical address to fetch the payload from a location allocated to the application within a memory.

### BACKGROUND OF THE INVENTION

As data center applications continue to process increasingly large amounts of information, the applications are increasingly relying on accelerators to perform their numerically intensive operations.

### BRIEF DESCRIPTION OF THE DRAWINGS

FIG. 1 shows an application invoking an accelerator invocation process;

FIGS. 2a and 2b show an improved accelerator invocation process;

FIG. 3 shows high performance computing environment;

FIGS. 4a and 4b depict an infrastructure processing unit (IPU).

### DETAILED DESCRIPTION

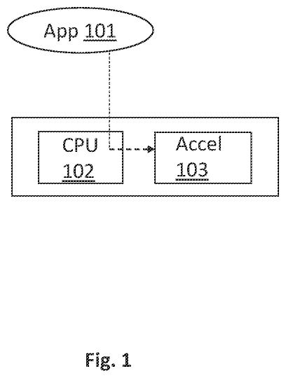

As observed in FIG. 1, one way to increase the performance of an application 101 that includes numerically intensive computations is to offload the computations from the application's CPU 102 to an accelerator 103 that is specially designed to perform the computations. Here, commonly, the CPU processing core 102 that the application is executing upon is a general purpose processing core that would consume many hundreds or thousands of program code instructions (or more) to perform the numerically intensive computations.

By contrast, the accelerator 103 is a special purpose hardware block (e.g., ASIC, special purpose processor) that is integrated into a common hardware platform with the CPU core 102 that can perform the application's numerically intensive computations as a service for the application 101. By off-loading the computations to the accelerator 103, the computations can be performed in far fewer instructions than the CPU core 102 (e.g., one instruction, a few instructions, etc.) thereby reducing the processing time consumed to perform the computations.

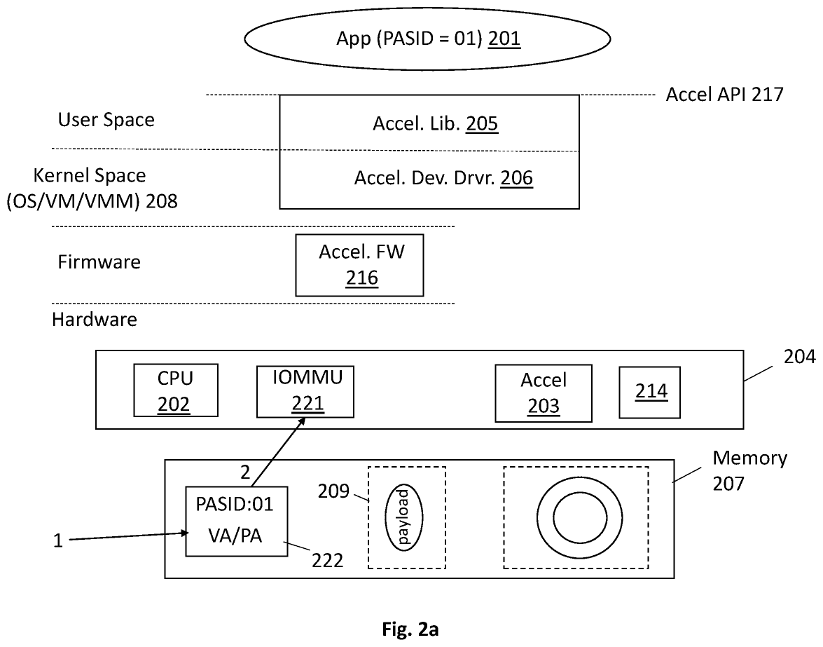

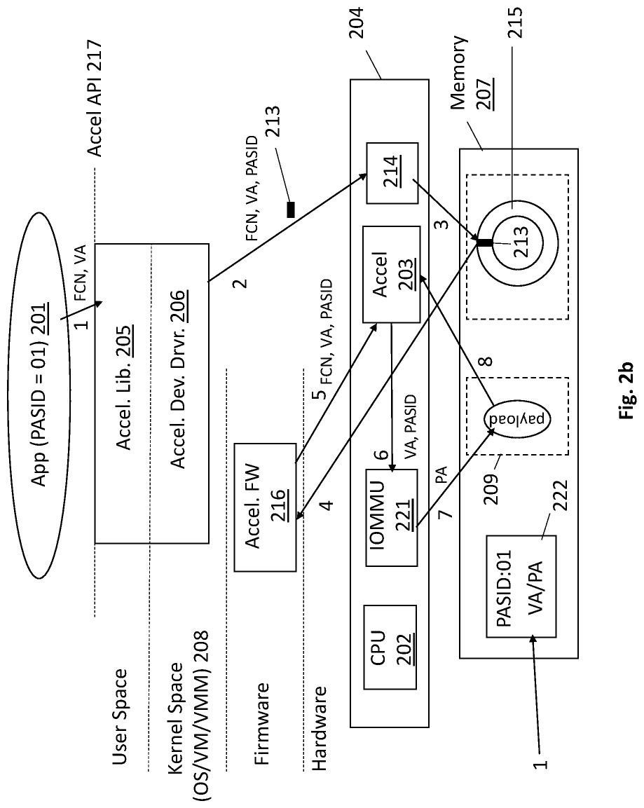

FIGS. 2a and 2b show an improved process for submitting input payloads to an accelerator 203. The improved process programs an I/O Memory Management Unit (IOMMU) 221 within a hardware platform 204 that includes a CPU core 202 that executes an application and an accelerator 203 with the virtual address translation information for the application 201.

An IOMMU is a unit of hardware that allows peripheral devices to issue read/write requests to memory 207, where, the read/write requests as issued by the peripheral devices specify a virtual address rather than a physical address (e.g., program code executing on a peripheral device can refer to memory with virtual addresses similar to an application 201). Here, at least with respect to payload related accesses made to memory 207 by the accelerator 203, the accesses can refer to a virtual address for the payload 209 and need not refer only to a physical address. Peripheral controllers that provide Peripheral Component Interconnect Express (PCIe) interfaces can include an IOMMU 207 (thus, in some embodiments, IOMMU 221 is integrated within such a peripheral controller).

Here, the application 201 is written to refer to virtual memory addresses. The application's kernel space 208 (which can include an operating system instance (OS) that executes on a virtual machine (VM), and a virtual machine monitor (VMM) or hypervisor that supports the VM's execution) comprehends the true amount of physical address space that exists in physical memory 207, allocates a portion of the physical address space 209 to the application 201, and configures the CPU 202 to convert, whenever the application 201 issues a read/write request to/from memory 207, the virtual memory address specified by the application 201 in the request to a corresponding physical memory addresses that falls within the application's allocated portion of memory 209.

Here, as observed in FIG. 2a, when the application 201 is being configured to use the accelerator 203, a process address space page 222 is loaded 1 into memory 207 for the application 201. CPU core 202 that executes the application 201 supports the execution of multiple, concurrent “processes” where each process corresponds to a stream of instructions having its own virtual address to physical address translation (the CPU maintains translation lookaside buffer (TLB) circuitry within its instruction execution pipeline(s) to implementation the virtual to physical address translation). Thus, commonly, a single application will consume a single process. Because the CPU core 202 can concurrently execute multiple processes, the CPU core 202 is able to concurrently execute multiple applications.

The process address space page 222 essentially describes the virtual to physical address translation of a particular CPU core process. Thus, if a particular process of the CPU core 202 is used to execute the application 201, the application's virtual to physical address translation information is described on the process's address space page 222. By binding an identifier of the application's particular CPU process to a particular PASID value (or if one identifier is used for both the process ID and the PASID), the application's memory space can be directly accessed by a peripheral device if the peripheral device associates the application's PASID with a read/write memory access that is issued by the peripheral device. In this manner, the same memory space 209 can be shared between the application 201 and the accelerator 203.

As described in more detail further below, such memory sharing allows the accelerator 203 to read an input payload directly from the application's memory space 209 which, in turn, eliminates the need to move 4 the payload from the application's memory space 109 to the application's accelerator memory space 111 as described above with respect to FIG. 1. Moreover, also as described further below, such memory sharing allows the application to identify the payload by its own virtual address without needing to perform a virtual/physical address translation request/response cycle 2, 3 as described above with respect to FIG. 1.

Thus, as observed in FIG. 2a, when the application 201 is being configured to use the accelerator 203, the process address space page 222 for the application's process is loaded into memory 207. The information on the page 222 is then loaded 2 into (e.g., register space of) the IOMMU 221. Subsequently, the IOMMU 221 can convert a virtual address for a payload in the application's memory space 209 that was contained in a memory access request issued to the IOMMU 221 by the accelerator 203 into the payload's actual physical address and fetch the payload from the application's memory space 209.

FIG. 2b depicts the process in more detail. As observed in FIG. 2b, when the application 201 desires to invoke the accelerator 203 to perform computations on a chunk of the application's data (referred to as a “payload”), the application 201 invokes the accelerator 203 by issuing a request 1 to the accelerator's software stack 205, 206 through the accelerator's API (the accelerator's software stack includes both library software 205 and device driver software 206, the library software 205 presents to the application 201 an application program interface (API) through which the application 201 can pass commands to invoke the accelerator 203).

The request 1 specifies the function (FCN) to be performed (e.g., cryptographic encoding, cryptographic decoding, compression, decompression, neural network processing, artificial intelligence machine learning, artificial intelligence inferencing, image processing, machine vision, graphics processing, etc.) and the virtual address (VA) for the payload within the application's memory space 209. In response, the accelerator's software stack 205/206 constructs a descriptor 213 that describes the function to be performed, the virtual address for the payload within the application's memory space 209 and the PASID for the process that is executing the application 201 (the accelerator's device driver 206 within kernel space 208 can determine the later).

The descriptor 213 is then passed 2 to circular buffer queue logic 214 which writes 3 the descriptor into a buffer queue 215 that feeds the accelerator 203. Here, according to one approach, the device driver 206 executes a special instruction (e.g., ENQCMD in the x86 architecture or equivalent in other processor architectures) that creates a descriptor 213 that includes the PASID. In another approach, the device driver 206 executes an instruction that writes the descriptor 213 with PASID to a MMIO location in register space of the hardware platform 204 (e.g., a control status register of the CPU 202). The kernel space 208 recognizes the activity and writes the descriptor 213 to the ring buffer queue logic 214 for entry into the ring buffer 215.

Here, buffer queue logic 214 is designed to cause memory space within the memory 207 to behave as a circular buffer 215. For example, the logic 214 is designed to: 1) read a next descriptor to be serviced by the accelerator 203 from the buffer 215 at a location pointed to by a head pointer; 2) rotate the head pointer about the address range of the buffer 215 as descriptors are continuously read from the buffer; 3) write each new descriptor to a location within the buffer 215 pointed to by a tail pointer; 4) rotate the tail pointer about buffer's address range in a direction opposite to 3) above as new descriptors are continuously entered into the buffer 215.

Thus, when the accelerator 203 is ready to process a next payload and the buffer queue's head pointer is pointing to the descriptor 213, the accelerator's firmware 216 reads 4 the descriptor 213 from the buffer queue 215 and programs 5 the descriptor's information (function, VA and PASID) into register space of the accelerator 203.

The accelerator 203 then issues a memory read request 6 to the IOMMU 221 that specifies the virtual address of the payload and the PASID. The IOMMU 221 converts the virtual address to the payload's actual physical address in the application memory space 209 and issues a read request 7 with the physical address to the memory 207. The payload is then read from the application's memory space 209 and passed 8 to the accelerator 203. Alternatively, after converting the virtual address to a physical address, the IOMMU 221 sends the physical address to the accelerator 203 which fetches the payload from the application's memory space 209.

When the accelerator 203 has completed its operation, it writes the response into a second, ring buffer queue in memory 207 (not shown in FIG. 2b for illustrative ease). The application 201 and/or software stack 205/206 can poll the second ring buffer for responses, or, logic circuitry associated with the second ring buffer can notify the application 201 and/or software stack 205/206 of the response.

The hardware platform 204 can be implemented in various ways. For example, according to one approach, the hardware platform 204 is a system-on-chip semiconductor chip. In this case, the CPU 202 can be a general purpose processing core that is disposed on the semiconductor chip and the accelerator 203 can be a fixed function ASIC block, special purpose processing core, etc. that is disposed on the same semiconductor chip. Note that in this particular approach, the CPU 202 and accelerator 203 are within a same semiconductor chip package. The IOMMU 221 can be integrated within the accelerator 203 so that it is dedicated to the accelerator, or, can be external to the accelerator 221 so that it performs virtual/physical address translation and memory access for other accelerators/peripherals on the SOC. In another similar approach, at least two semiconductor chips are used to implement the CPU 202, accelerator 203, the IOMMU 221 and the memory 207 and both chips are within a same semiconductor chip package.

In another approach, the hardware platform 204 is an integrated system, such as a server computer. Here, the CPU 202 can be a multicore processor chip disposed on the server's motherboard and the accelerator 203 can be, e.g., disposed on a network interface card (NIC) that is plugged into the computer. In another approach, the hardware platform 204 is a disaggregated computing system in which different system component modules (e.g., CPU, storage, memory, acceleration) are plugged into one or more racks and are communicatively coupled through one or more networks.

In various embodiments the accelerator 203 can perform one of compression and decompression (compression/decompression) and one of encryption and decryption (encryption/decryption) in response to a single invocation by an application.

In various embodiments, the process address space page 222, the payload 209, and/or the ring buffer 215 are maintained and/or accessed within a trusted execution environment (TEE) (e.g., Software Guard eXtensions (SGX) and Trust Domain Extensions (TDX) from Intel Corporation, and, Secure Encrypted Virtualization (SEV) from Advanced Micro Devices (AMD) Corporation) and/or the application's software stack 205/206 executes in a TEE. In various virtualized embodiments (e.g., where virtual machines support the execution of applications as described further below), the process address space page 222, the payload 209, and/or the ring buffer 215 are maintained and/or accessed with hardware assisted I/O virtualization (e.g., as described in the “Intel Scalable I/O Virtualization (SIOV) Technical Specification”, Rev. 1.1, September 2020, published by Intel Corporation or other equivalent) and/or the application's software stack 205/206 relies upon (uses) hardware assisted I/O virtualization.

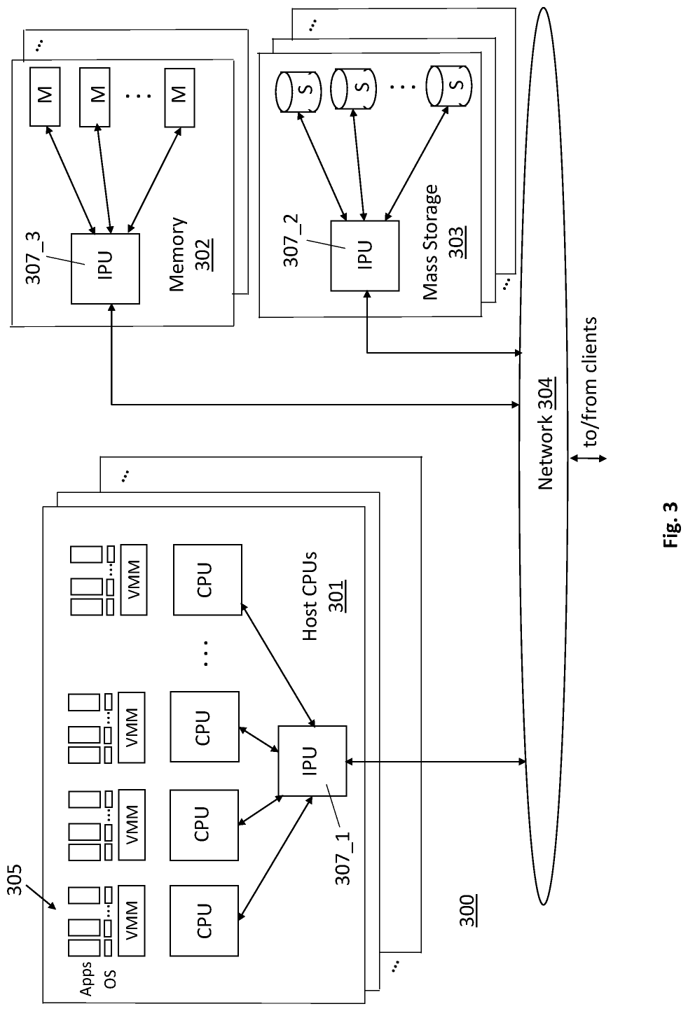

FIG. 3 shows a new, emerging high performance computing environment (e.g., data center) paradigm in which “infrastructure” tasks are offloaded from traditional general purpose “host” CPUs (where application software programs are executed) to an infrastructure processing unit (IPU), data processing unit (DPU) or smart networking interface card (SmartNIC), any/all of which are hereafter referred to as an IPU.

Networked based computer services, such as those provided by cloud services and/or large enterprise data centers, commonly execute application software programs for remote clients. Here, the application software programs typically execute a specific (e.g., “business”) end-function (e.g., customer servicing, purchasing, supply-chain management, email, etc.). Remote clients invoke/use these applications through temporary network sessions/connections that are established by the data center between the clients and the applications.

In order to support the network sessions and/or the applications' functionality, however, certain underlying computationally intensive and/or trafficking intensive functions (“infrastructure” functions) are performed.

Examples of infrastructure functions include encryption/decryption for secure network connections, compression/decompression for smaller footprint data storage and/or network communications, virtual networking between clients and applications and/or between applications, packet processing, ingress/egress queuing of the networking traffic between clients and applications and/or between applications, ingress/egress queueing of the command/response traffic between the applications and mass storage devices, error checking (including checksum calculations to ensure data integrity), distributed computing remote memory access functions, etc.

Traditionally, these infrastructure functions have been performed by the CPU units “beneath” their end-function applications. However, the intensity of the infrastructure functions has begun to affect the ability of the CPUs to perform their end-function applications in a timely manner relative to the expectations of the clients, and/or, perform their end-functions in a power efficient manner relative to the expectations of data center operators. Moreover, the CPUs, which are typically complex instruction set (CISC) processors, are better utilized executing the processes of a wide variety of different application software programs than the more mundane and/or more focused infrastructure processes.

As such, as observed in FIG. 3, the infrastructure functions are being migrated to an infrastructure processing unit. FIG. 3 depicts an exemplary data center environment 300 that integrates IPUs 307 to offload infrastructure functions from the host CPUs 304 as described above.

As observed in FIG. 3, the exemplary data center environment 300 includes pools 301 of CPU units that execute the end-function application software programs 305 that are typically invoked by remotely calling clients. The data center also includes separate memory pools 302 and mass storage pools 305 to assist the executing applications. The CPU, memory storage and mass storage pools 301, 302, 303 are respectively coupled by one or more networks 304.

Notably, each pool 301, 302, 303 has an IPU 307_1, 307_2, 307_3 on its front end or network side. Here, each IPU 307 performs pre-configured infrastructure functions on the inbound (request) packets it receives from the network 304 before delivering the requests to its respective pool's end function (e.g., executing software in the case of the CPU pool 301, memory in the case of memory pool 302 and storage in the case of mass storage pool 303). As the end functions send certain communications into the network 304, the IPU 307 performs pre-configured infrastructure functions on the outbound communications before transmitting them into the network 304.

Depending on implementation, one or more CPU pools 301, memory pools 302, mass storage pools 303 and network 304 can exist within a single chassis, e.g., as a traditional rack mounted computing system (e.g., server computer). In a disaggregated computing system implementation, one or more CPU pools 301, memory pools 302, and mass storage pools 303 are separate rack mountable units (e.g., rack mountable CPU units, rack mountable memory units (M), rack mountable mass storage units (S)).

In various embodiments, the software platform on which the applications 305 are executed include a virtual machine monitor (VMM), or hypervisor, that instantiates multiple virtual machines (VMs). Operating system (OS) instances respectively execute on the VMs and the applications execute on the OS instances. Alternatively or combined, container engines (e.g., Kubernetes container engines) respectively execute on the OS instances. The container engines provide virtualized OS instances and containers respectively execute on the virtualized OS instances. The containers provide isolated execution environment for a suite of applications which can include, applications for micro-services.

With respect to the hardware platform 204 of the improved accelerator invocation process described just above with respect to FIGS. 2a and 2b, in various embodiments, the hardware platform 204 corresponds to the paradigm of FIG. 3 in which the CPU 202 corresponds to one or more CPUs within a CPU pool 301, the memory 207 corresponds to one or memory units within the memory pool 302 and the accelerator 203 is a component within an accelerator/acceleration pool that is not depicted in FIG. 3 but follows the same approach as the other pools 301, 302, 303 (multiple accelerators are coupled to network 304 through an IPU).

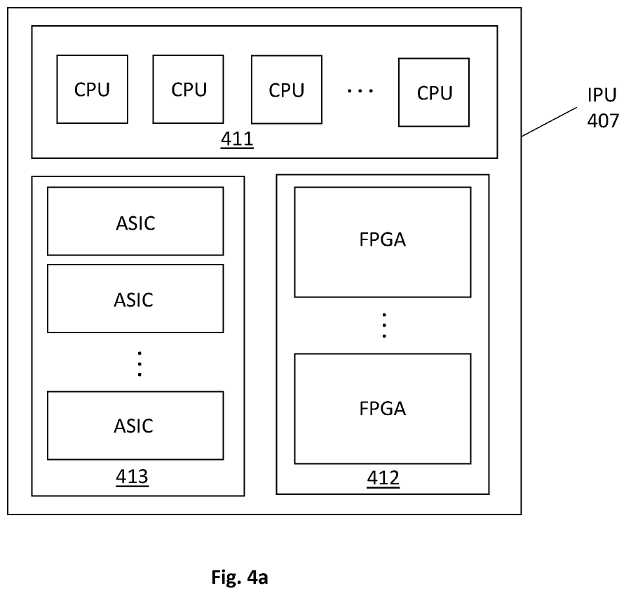

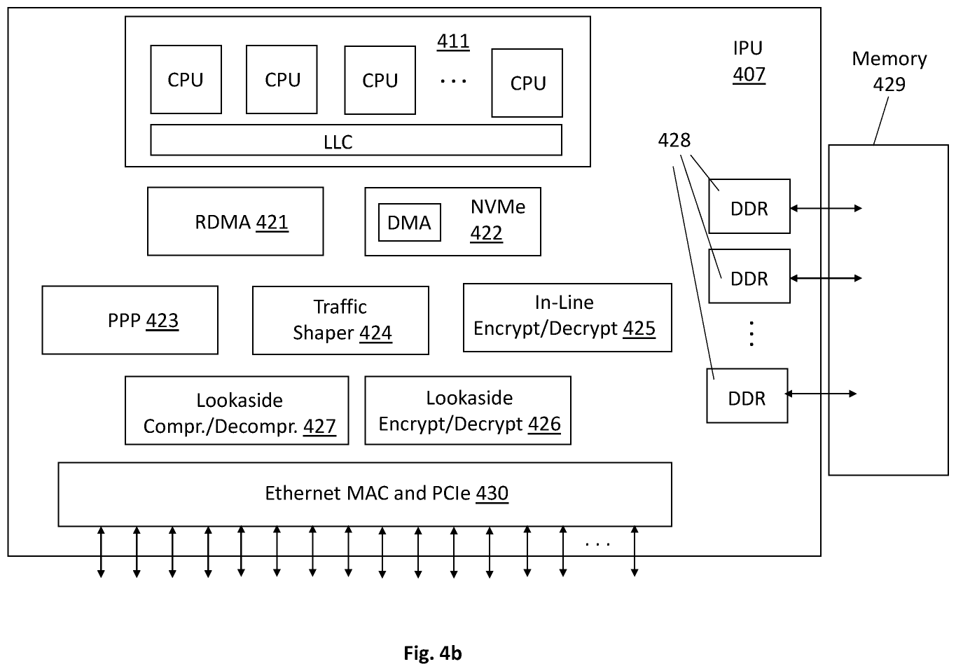

FIG. 4a shows an exemplary IPU 407. As observed in FIG. 4 the IPU 409 includes a plurality of general purpose processing cores 411, one or more field programmable gate arrays (FPGAs) 412, and/or, one or more acceleration hardware (ASIC) blocks 413. An IPU typically has at least one associated machine readable medium to store software that is to execute on the processing cores 411 and firmware to program the FPGAs (if present) so that the processing cores 411 and FPGAs 412 (if present) can perform their intended functions.

With respect to the hardware platform 204 of the improved accelerator invocation process described just above with respect to FIGS. 2a and 2b, in various embodiments, the hardware platform 204 is an IPU 407 in which the CPU 202 corresponds to one or more CPUs 411 and the accelerator 203 is an FPGA 412 or an ASIC block 413.

The processing cores 411, FPGAs 412 and ASIC blocks 413 represent different tradeoffs between versatility/programmability, computational performance and power consumption. Generally, a task can be performed faster in an ASIC block and with minimal power consumption, however, an ASIC block is a fixed function unit that can only perform the functions its electronic circuitry has been specifically designed to perform.

The general purpose processing cores 411, by contrast, will perform their tasks slower and with more power consumption but can be programmed to perform a wide variety of different functions (via the execution of software programs). Here, it is notable that although the processing cores can be general purpose CPUs like the data center's host CPUs 301, in many instances the IPU's general purpose processors 411 are reduced instruction set (RISC) processors rather than CISC processors (which the host CPUs 301 are typically implemented with). That is, the host CPUs 301 that execute the data center's application software programs 305 tend to be CISC based processors because of the extremely wide variety of different tasks that the data center's application software could be programmed to perform.

By contrast, the infrastructure functions performed by the IPUs tend to be a more limited set of functions that are better served with a RISC processor. As such, the IPU's RISC processors 411 should perform the infrastructure functions with less power consumption than CISC processors but without significant loss of performance.

The FPGA(s) 412 provide for more programming capability than an ASIC block but less programming capability than the general purpose cores 411, while, at the same time, providing for more processing performance capability than the general purpose cores 411 but less than processing performing capability than an ASIC block.

FIG. 4b shows a more specific embodiment of an IPU 407. The particular IPU 407 of FIG. 4b does not include any FPGA blocks. As observed in FIG. 4b the IPU 407 includes a plurality of general purpose cores (e.g., RISC) 411 and a last level caching layer for the general purpose cores 411. The IPU 407 also includes a number of hardware ASIC acceleration blocks including: 1) an RDMA acceleration ASIC block 421 that performs RDMA protocol operations in hardware; 2) an NVMe acceleration ASIC block 422 that performs NVMe protocol operations in hardware; 3) a packet processing pipeline ASIC block 423 that parses ingress packet header content, e.g., to assign flows to the ingress packets, perform network address translation, etc.; 4) a traffic shaper 424 to assign ingress packets to appropriate queues for subsequent processing by the IPU 409; 5) an in-line cryptographic ASIC block 425 that performs decryption on ingress packets and encryption on egress packets; 6) a lookaside cryptographic ASIC block 426 that performs encryption/decryption on blocks of data, e.g., as requested by a host CPU 301; 7) a lookaside compression ASIC block 427 that performs compression/decompression on blocks of data, e.g., as requested by a host CPU 301; 8) checksum/cyclic-redundancy-check (CRC) calculations (e.g., for NVMe/TCP data digests and/or NVMe DIF/DIX data integrity); 9) thread local storage (TLS) processes; etc.

The IPU 407 also includes multiple memory channel interfaces 428 to couple to external memory 429 that is used to store instructions for the general purpose cores 411 and input/output data for the IPU cores 411 and each of the ASIC blocks 421-426. The IPU includes multiple PCIe physical interfaces and an Ethernet Media Access Control block 430 to implement network connectivity to/from the IPU 409. As mentioned above, the IPU 407 can be a semiconductor chip, or, a plurality of semiconductor chips integrated on a module or card (e.g., a NIC).

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard wired interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a memory management unit, the memory management unit to receive a memory access request from an accelerator, wherein the memory access request includes a virtual address of a payload provided by an application that invokes the accelerator to perform a function on the payload, wherein, the memory access request also includes an identifier of the application's CPU process, the memory management unit to translate the virtual address to a physical address to fetch the payload from a location allocated to the application within a memory.

2. The apparatus of claim 1 wherein the memory management unit is to process, during the memory management unit's configuration, a page within the memory that includes the identifier of the application's CPU process and virtual to physical address translation information for the application.

3. The apparatus of claim 1 wherein the memory management unit is an I/O memory management unit (IOMMU).

4. The apparatus of claim 1 wherein the memory management unit is within a same semiconductor chip package as the accelerator.

5. The apparatus of claim 1 wherein the accelerator is a component of a network interface card (NIC).

6. The apparatus of claim 1 wherein the accelerator includes circuitry to perform compression/decompression.

7. The apparatus of claim 1 wherein the application's CPU process is identified with a PASID.

8. An apparatus, comprising:
an accelerator, the accelerator to receive a first identifier of an operation to be performed for an application by the accelerator, a second identifier of the application's CPU process, and a virtual address used by the application to refer to the operation's payload, the accelerator to pass a request to a memory management unit that includes the second identifier and the virtual address, the request to cause the memory management unit to translate the virtual address to a physical address for the payload within a region of a memory allocated to the application.

9. The apparatus of claim 8 wherein the accelerator comprises register space to store the first identifier, the second identifier and the virtual address.

10. The apparatus of claim 8 wherein the memory management unit is an I/O memory management unit (IOMMU).

11. The apparatus of claim 8 wherein the memory management unit is within a same semiconductor chip package as the accelerator.

12. The apparatus of claim 8 wherein the accelerator is a component of a network interface card (NIC).

13. The apparatus of claim 8 wherein the accelerator includes circuitry to perform compression/decompression.

14. The apparatus of claim 8 wherein the accelerator includes circuitry to perform at least one of encryption/decryption and compression/decompression in response to a single invocation.

15. A data center comprising:
a network;
a CPU pool coupled to the network;
an application to execute on a process of the CPU pool;
a memory pool coupled to the network; and,
an acceleration pool coupled to the network, the acceleration pool comprising an accelerator, the accelerator to receive a first identifier of an operation to be performed for the application by the accelerator, a second identifier of the application's CPU process, and a virtual address used by the application to refer to the operation's payload, the accelerator to pass a request to a memory management unit that includes the second identifier and the virtual address, the request to cause the memory management unit to translate the virtual address to a physical address for the payload within a region of the memory pool allocated to the application.

16. The data center of claim 15 wherein the accelerator comprises register space to store the first identifier, the second identifier and the virtual address.

17. The data center of claim 15 wherein the memory management unit is an I/O memory management unit (IOMMU).

18. The data center of claim 15 wherein the accelerator includes circuitry to perform compression/decompression.

19. The data center of claim 15 wherein the accelerator includes circuitry to perform encryption/decryption.

20. The data center of claim 15 wherein the CPU pool, memory pool and acceleration pool are coupled to the network through respective IPUs.
